(19) United States
(12) Patent Application Publication
(10) Pub. No.: US 2004/0147656 A1
(43) Pub. Date: Jul. 29, 2004

(54) Emulsion composition, coating film formed therefrom, and cooling mechanism using the coating film

(75) Inventors: Masahiro Machida, Tokyo (JP); Noriyuki Kaneko, Tokyo (JP); Kouichiro Shimizu, Tokyo (JP); Yuuichi Deushi, Tokyo (JP); Masahito Nozue, Tokyo (JP)

Correspondence Address: VENABLE, BAETJER, HOWARD AND CIVILETTI, LLP, P.O. BOX 34385, WASHINGTON, DC, 20043-9998, US

(73) Assignees: Ceramission Co., Ltd., Tokyo (JP); Oki Electric Industry Co., Ltd., Tokyo (JP)

(21) Appl. No.: 10/735,927

(22) Filed: Dec. 16, 2003

(30) Foreign Application Priority Data
Dec. 16, 2002 (JP) JP2002-363325
Sep. 10, 2003 (JP) JP2003-318585

(51) Int. Cl. C08K 3/18; C08K 3/34

(52) U.S. Cl. 524/430; 524/447

(57) ABSTRACT

To provide a composition for easily forming a coating film that has both cooling and heat shielding properties. An emulsion composition in which a metallic oxide such as kaolin, silicon oxide, aluminum oxide or the like is included in a silicone resin emulsion is made, and this emulsion composition is coated onto a substrate such as a drive motor, or an integrated circuit, or printed circuit board or the like on which these devices are mounted, to thereby form a coating film, and the temperature of the parts and devices on which the coating film is formed is decreased, thus improving their reliability and stability.

### Background of the Invention

This invention relates to an emulsion composition in which metallic oxide is included in a silicone emulsion, a coating film formed therefrom, and a cooling mechanism that uses the coating film.

1. Description of the Related Art

Generally, electronic parts such as integrated circuits, power transistors, and resistors for CPU elements and the like, electric and/or electronic devices for hard disk drives and inverters, and driving apparatuses such as motors generate heat when in use. A heat-radiating fin or the like is used to radiate the heat from these parts and devices, thereby suppressing temperature increase of these parts and devices, and maintaining their characteristics and reliability.

Also, the small size and high performance of these devices and apparatuses has made effective cooling of the parts and devices used therein necessary.

Usually, in the above-mentioned devices and apparatuses, heat released from the heat sink which has a heat-radiating fin, is scavenged to the outside by a cooling fan, and the heat from the inside of the device is thereby radiated. Also, heat radiation may be carried out by providing a sheet made of heat conducting material between the device and the heat sink, so that the heat generated is efficiently conducted to the heat sink via the heat conduction sheet.

Meanwhile, objects that do not themselves generate heat, but whose characteristics are compromised, or which become less reliable when used in a high temperature environment, must be shielded from heat in order to suppress temperature increase of these devices.

For example, the motor in the cooling fan used for radiating heat generates little heat itself, but is affected by the hot air inside of the apparatus as scavenging takes place. The temperature of the motor itself increases and cooling is sometimes shortened.

In this manner, the heat-radiating fin or cooling fan that is usually effective in radiating the heat, become disadvantageous as a result of device being made compact. Thus, it has become necessary to effectively cool the parts and devices in small devices, and to shield the motor of the cooling fan for scavenging the heat released inside the apparatus. As a result, development of technology that would allow the parts and devices to be shielded and cooled by a single means was long awaited. (Parts and devices that generate heat themselves will be referred to as heat generating bodies, while those that generate little heat themselves, but which need to be shielded from heat will be referred to as bodies for shielding.)

### SUMMARY OF THE INVENTION

The inventors of this invention focused on developing a coating film that has both cooling and shielding properties as the technology for realizing this invention, and carried out their research. They found that a coating film comprising a metallic oxide that includes kaolin was effective in combining both cooling and heat shielding properties.

In addition, they discovered a silicone resin which is advantageous in terms of heat resistance, electrical properties, adhesive properties, and film forming properties, and which does not include metallic ions (particularly sodium ions) that have an adverse effect on devices and apparatuses related to semiconductors, is effective as a binder for forming the coating film comprising the metallic oxide. By including a composition containing metallic oxide (referred to as emulsion composition) in the emulsion containing the silicone resin (referred to as silicone resin emulsion), this invention was completed.

The silicone resin emulsion of the prior art is used as a coating material for a building material with excellent weather resistance; water resistance and freeze and melt resistance properties (For example, refer to Japanese Patent Laid-open Publication No. 2000-72883 (page 3)). In addition, they are also used as outer wall coating or coating material having excellent self cleaning properties by including a photo-catalyst element in the silicone resin emulsion. (For example, refer to Japanese Patent Laid-open Publication No. 10-279886 (Page 4)).

However, all of the above-mentioned prior art technology are coating materials used as building material, and the technology of this invention in which a coating film having both cooling and heat shielding properties is formed by including metallic oxides in a silicone resin emulsion is unknown hitherto.

This invention was developed in view of the present situation, and the object thereof is to provide a composition for easily forming a coating film that combines both cooling and heat shielding properties.

In order to solve the abovementioned problems, this invention is an emulsion composition in which metallic oxide is included in the emulsion containing the silicone resin.

As the metallic oxide, at least one of: kaolin; silicon oxide; aluminum oxide; titanium oxide; zirconium oxide; antimony oxide; germanium oxide; boron oxide; calcium oxide; barium oxide; strontium oxide; bismuth oxide; copper oxide; and talc is included in the emulsion containing silicone resin.

In addition to the metallic oxide, at least one of nitrides including: silicon nitride; aluminum nitride; zirconium nitride; copper nitride; strontium nitride; titanium nitride; barium nitride and the like is included.

The proportion of the emulsion containing silicone resin in the emulsion composition is 30-70 weight percent.

The proportion of kaolin in the emulsion composition is 7-20 weight percent.

The coating film is formed from the above-mentioned emulsion composition.

The above-mentioned coating film is formed on at least one portion of the surface of a substrate.

### BRIEF DESCRIPTION OF THE DRAWINGS

FIG. 1A is a front view of the test specimen (blank) of Working Example 6.

FIG. 1B is a front view of the test specimen (Specimen A) of Working Example 6.

FIG. 1C is a front view of the test specimen (Specimen B) of Working Example 6.

FIG. 2 is a cross-sectional view of the printed circuit board of Working Example 6.

FIG. 3A is a cross-sectional view of the test specimen (blank) of Working Example 7.

FIG. 3B is a cross-sectional view of the test specimen (Specimen C) of Working Example 7.

FIG. 3C is a cross-sectional view of the test specimen (Specimen D) of Working Example 7.

FIG. 3D is a cross-sectional view of the test specimen (Specimen E) of Working Example 7.

FIG. 3E is a cross-sectional view of the test specimen (Specimen F) of Working Example 7.

FIG. 4A is a perspective view of Embodiment 1.

FIG. 4B is a perspective view of Embodiment 1.

FIG. 5A is a cross-sectional view of Embodiment 2.

FIG. 5B is a cross-sectional view of Embodiment 2.

FIG. 6A is a perspective view of Embodiment 3.

FIG. 6B is a perspective view of Embodiment 3.

### DETAILED DESCRIPTION OF THE EMBODIMENTS

The following is a description of working examples of the emulsion composition of this invention.

It is to be noted that the word emulsion refers to the silicon resin being dispersed in an emulsion state, and metallic oxide being dispersed in the silicone resin emulsion. The metallic oxide included in the emulsion composition is preferably kaolin, and silicon oxide and aluminum oxide are also preferable. Also, kaolin and silicon oxide or aluminum oxide respectively may be mixed and used in the emulsion composition.

Other examples of the metallic oxide that may be used include titanium oxide; zirconium oxide; antimony oxide, germanium oxide; boron oxide; calcium oxide; barium oxide; strontium oxide; bismuth oxide; copper oxide; and talc.

Nitrides which may also be included in the emulsion composition comprising the metallic oxide include nitrides with excellent heat conductance such as: boron nitride; aluminum nitride; zirconium nitride; copper nitride, strontium nitride; titanium nitride and barium nitride.

The particles of the metallic oxide and the nitride may be ground in a grinder such as a ball mill or a jet mill and used in a powdered state, and particularly, a finely powdered state is favorable.

The silicone resin is one which has excellent heat resistance, adhesive properties, electrical properties and film forming properties; functions as the binder for the metallic oxides and nitride by causing adhesion of the metallic oxide and nitride powders; and which also forms a stable and strong coating film by causing the metallic oxide and the nitride to adhere to the coating surface.

The silicone resin emulsion is an emulsion in which mainly a non-aqueous soluble silicone resin is dispersed in water, and may for example, be obtained by the following methods.

(1) A method for forming an aqueous emulsion in which an alkyl silicate compound or a partial hydrolysis or condensation product thereof is emulsified using surfactants. (Japanese Patent Laid-open Publication No. 58-213046, Japanese Patent Laid-open Publication No. 62197369, Japanese Patent Laid-open Publication No. 3-115485, Japanese Patent Laid-open Publication No. 3-200793. There is also a method where an emulsion in which a polymerized vinyl monomer is subjected to emulsion polymerization is mixed with this emulsion. (Japanese Patent Laid-open Publication No. 6-344665)

(2) A method that does not use a surfactant, in which a vinyl monomer capable of radical polymerization is subjected to emulsion polymerization in the presence of an aqueous polymer obtained by hydrolyzing an alkyl silicate compound in water. (Japanese Patent Laid-open Publication No. 8-60098)

(3) A method in which an alkyl silicate compound that contains a vinyl polymerized alkyl silicate is subjected to hydrolysis/condensation to form an aqueous emulsion including a hard silicone resin, and then adding a radical polymerized vinyl monomer and carrying out emulsification polymerization to thereby obtain a graft copolymer fine particle (solid) emulsion. (Japanese Patent Laid-open Publication No. 5-209149, Japanese Patent Laid-open Publication No. 7-196750)

(4) A method in which an alkyl silicate compound is added to an emulsion whose radical polymerized functional group is subjected to emulsification polymerization, and is hydrolyzed/condensed, and then silicone resin is introduced into the emulsion particles. (Japanese Patent Laid-open Publication No. 3-45628, Japanese Patent Laid-open Publication No. 8-3409)

(5) A method for making an emulsion in which an alkyl silicate having a vinyl polymerized functional group and a radical polymerized vinyl monomer are both subjected to emulsion polymerization. (Japanese Patent Laid-open Publication No. 61-9463, Japanese Patent Laid-open Publication No. 8-27347) The emulsion composition may be obtained by adding and mixing a metallic oxide powder with a silicone resin emulsion.

In other words, the silicon resin emulsion is really silicone resin dispersed in water, and thus the metallic oxide may be mixed in the water as a suspension, to thereby obtain an emulsion composition including the metallic oxide.

It is to be noted that because the silicone resin emulsion of the emulsion composition contains water as described above, if the amount of metallic oxide or nitrides in the emulsion composition is relatively large, the viscosity of the emulsion composition may become high. In this case, water may be appropriately added to the emulsion composition so as to adjust the viscosity.

Also, in the case where the viscosity of the emulsion composition is low due a large amount of water in the silicone resin emulsion, the viscosity may be adjusted by appropriately adding thickener or the like.

The metallic oxide in the emulsion composition is preferably kaolin as described above, and the amount of kaolin to be used is preferably 7-20 weight percent of the emulsion composition.

That is to say, if the amount of kaolin is less than 7 weight percent, the cooling properties and the heat shielding properties will be insufficient, and if it exceeds 20 weight percent, the stability of the coating film and the adhesiveness of the coating film to the surface on which it is to be formed is lowered.

Also, the proportion of the silicone resin emulsion in the emulsion composition is preferably 30-70 weight percent.

That is, if the amount of the silicone resin emulsion is less than 30 weight percent, the stability of the coating film, and the adhesiveness of the coating film -to the surface on which it is to be formed is lowered, and if the amount of the silicon resin emulsion exceeds 70 weight percent, the amount of the metallic oxide will be relatively low, and the cooling and heat shielding properties will be lowered.

The following is a description of the effects of the emulsion composition described above.

The formation of the coating film from the emulsion composition is done by coating the emulsion composition directly onto the surface of objects such as the heat generating body or the body for heat shielding, or brackets, fins and the like mounted thereto (referred to as the substrate) by brushing, spraying, dipping, screen printing and the like, and then air drying at ordinary temperature.

The drying may be done, if necessary, in a drying furnace (for example, drying for one hour in a 125° C. drying furnace), and may also be done with hot air such as with a dryer.

It is to be noted that in forming the coating film, the emulsion composition may be coated onto a substrate that was prepared beforehand so as to have a predetermined shape, or the substrate maybe processed into a predetermined shape after the coating film has been formed from the emulsion composition on the substrate.

In the above description, the emulsion composition was coated directly on the substrate, but the emulsion composition may be coated onto a film or sheet made of paper, woven fabric, unwoven fabric, resin or metal, and then the coating film is formed as described above to produce a heat radiating or heat shielding film or sheet. This may be cut in the shape of the substrate or in some predetermined shape, and two-sided tape (preferably two-sided tape that has heat conductance properties) is adhered surface of the substrate opposite to that with the coating film, and then pasted at a predetermined position on the substrate.

In this case, silicone resin is the binder for the coating film formed from the emulsion composition of this invention, and thus cutting with scissors, a punch, by press-cutting, or with laser is possible and thus cooling and heat-shielding of the substrate is not labor intensive.

It is to be noted that the thickness of the coating film formed from the emulsion composition of this invention is about 10-200 μm, and preferably 20-100 μm.

Because the coating film formed from the emulsion composition of the present invention includes kaolin and a metallic oxide such as silicon oxide or aluminum oxide, the heat that is conducted to the coating film is converted to infrared light and/or far infrared light and radiated. Thus the coating film has the function of radiating infrared light. As a result, the heat conducted by the substrate is radiated to the outside and the substrate is cooled.

Also, the heat that is absorbed from the outside by the coating film is radiated back to the outside due to the infrared light radiating function, and thus heat penetration of the substrate is suppressed, and heat shielding properties are thereby exhibited.

In the case where nitrides such as boron nitride and aluminum nitride are included in the above-described including metallic oxide, due to the excellent heat conductivity of nitride, conduction of heat from the substrate and the absorption of heat from the outside are promoted, and thus the cooling and heat shielding properties of the coating film are more effective.

Substrates that require cooling and heat shielding are mainly various electric and electronic devices and their parts. For example, if the above-described coating film is formed on a known heat-radiating body (heat sink) that has a heat-radiating fin that includes plate-shaped, semicircular, or disc-shaped protrusions, the cooling effect of the known heat-radiating body can be increased.

Also, by pasting a heat-radiating/heat shielding film or sheet onto the electronic parts of an integrated circuit or the like, the cooling effect of that part can be increased.

The following is a description of working examples in which this invention is applied to specific parts.

### WORKING EXAMPLE 1

The emulsion composition used in this working example is obtained by mixing the following in the following weight ratios: silicone resin emulsion 50.8, kaolin 12, silicon oxide 8.2, aluminum oxide 12.3, titanium oxide 6.2, and zirconium oxide 10.5.

This emulsion composition was coated onto an L-shaped aluminum plate, and air dried to form a coating film with a thickness of 50 μm, and this was mounted in a power module as a heat-radiating body. It is to be noted that this L-shaped plate also functions as a support frame for the power module.

The temperature of this type of power module while it was being operated was found to have an average temperature of 55.5° C. when measured at 6 locations on the power module main body. Meanwhile, when the temperature of a similar power module that did not have the heat-radiating body mounted was measured while being operated in a similar manner, it was found that the average temperature was 62.2° C.

This shows that heat that builds up in the power module main body is conducted to the coating film via the heat-radiating plate due to heat conductance, and due to the infrared light function of the coating film, the heat is radiated, and consequently the power module main body is cooled, and thus better cooling properties are exhibited than when the heat-radiating body without the coating film formed is installed.

As a result, temperature increase of power module main body is suppressed, and thus malfunctions due to temperature dependency are prevented, thus increasing the reliability and stability of the power module. Also, it was found that the temperature of the power module main body was 2-20° C. lower when the coating film was formed on the heat-radiating body of the power module that is equipped with a heat-radiating fin, than in the case where a heat-radiating body without the coating film was installed.

### WORKING EXAMPLE 2

The emulsion composition used in this working example is the same as the emulsion composition used in Working Example 1.

In this working example, the emulsion composition was coated on the back and front surfaces of the motor of a cooling fan to form coating film with a thickness of 40 μm.

This type of cooling fan motor was placed at a 10 mm position in front of a heat gun, and a heat detecting terminal was mounted on the motor shaft on the back surface of the motor. The heat gun was fired while the motor was in a stopped state in a room with a temperature of 26.1° C., and the increase in temperature of the motor shaft was measured.

After approximately 30 minutes, the temperature of the motor shaft reached a state of equilibrium, and the temperature of the motor shaft in the equilibrium state was 65.2° C. Meanwhile, the temperature of the motor shaft in the motor of the cooling fan on which the coating film was not formed was 75.4° C.

This shows that the coating film of this invention has a heat shielding effect, and confirms that due to the coating film formed by coating on the emulsion composition of this invention, the heat absorbed by the coating film is radiated out again, and temperature increase of the motor of the cooling fan is suppressed.

### WORKING EXAMPLE 3

The emulsion composition used in this working example was obtained by mixing its constituents in the following weight ratios: silicone resin emulsion 34.1, kaolin 12, silicon oxide 8.5, and aluminum oxide 12.5.

This emulsion composition was coated onto a heat-radiating v of a drive motor to form a coating film having a thickness of 45 μm.

This drive motor was driven and the temperature was measured at 5 locations of the heat-radiating casing. The average of the temperatures at equilibrium was 70.0° C. Meanwhile, the average temperature measured in the same manner for a similar drive motor on which the coating film was not formed was 101° C.

This also confirms that the coating film formed from the emulsion composition of this invention has an excellent cooling effect.

### WORKING EXAMPLE 4

The emulsion composition used in this working example is the same emulsion composition as that used in Working Example 3.

In this working example, the emulsion composition was coated on the connecting portion of a fluorescent lamp to form a coating film. The fluorescent lamp used was a 15W vertical lamp.

The fluorescent lamp was switched on, and after 1 hour, the temperature and the brightness at the position 30 cm directly below the fluorescent lamp was measured, and the temperature of the connecting portion was 55° C. and the brightness was 125 lux. Meanwhile the temperature of the connecting portion of the fluorescent lamp on which the coating film was not formed was 77° C., and the brightness was 98 lux.

This confirms that the coating film being formed on the connecting portion has the effect of radiating the heat that accumulated in the fluorescent lamp, and thus the temperature of the fluorescent lamp was reduced and the brightness was increased.

### WORKING EXAMPLE 5

The emulsion composition used in this working example was obtained by mixing the following in the following weight ratios: silicone resin emulsion 51, kaolin 12.5, silicon oxide 8, aluminum oxide 13, titanium oxide 5, and zirconium oxide 8.

This emulsion composition was coated onto one surface of an aluminum sheet with a thickness of 1mm to form a coating film having a thickness of 100 μm, and two-sided tape was pasted onto the other surface to thereby form a heat radiating/heat shielding sheet material for the aluminum sheet.

This heat radiating/heat shielding sheet was pasted on 5 surfaces of a stainless steel heat block (a square with length of one side being 40 mm and a height of 20 mm) having a thermocouple and a heater, with the exception of the surface with the heater current and thermocouple terminals. It was installed in this state at atmospheric temperature of 25° C., current was supplied to the heater, and the temperature of the heat block was measured after 2 hours when the temperature reached equilibrium.

It is to be noted that the thermocouple was installed at the center of the heat block.

The temperature of the heat block was 48.8° C. when the electric power supplied was 2W, 76.0 when the electric power supplied was 5W, and 102.6 when the electric power supplied was 8W. Meanwhile, the temperature of the heat block that did not have the heat radiating/heat shielding sheet was 60.2° C. when the electric power supplied was 2W, 99.8° C. when the electric power supplied was 5W, and 133.6° C. when the electric power supplied was 8W.

This confirms that pasting on the heat radiating/heat shielding aluminum sheet formed from the coating film from the emulsion composition of this invention has the same cooling effect as when the coating film is directly coated on.

As described above, the coating film formed from the emulsion composition of this invention achieves the effect of suppressing temperature increase in various kinds of electric and electronic devices.

That is to say, in heat generating bodies that generate a large amount of heat, heat is radiated and cooling is thereby carried out. For bodies for heat shielding that are in a high temperature environment, the heat that is absorbed is radiated again and thus the effect of heat shielding from high temperatures is achieved.

As described above, by coating the surface of substrates that are bodies for heat shielding which conduct heat from heat generating bodies, the heat that is conducted from the substrate to the coating film is converted to infrared/ and or far infrared light, and is radiated as light energy, and thus the coating film formed from the emulsion composition of this invention exhibits a cooling effect and a heat shielding effect. As described above, examples of the heat generating bodies include electrical parts like the drive motor and the fluorescent lamp, and electronic parts such as the power module, and examples of bodies for heat shielding include the brackets and the heat-radiating fin, as well as the cooling fan when not in operation.

The formation of the coating film on the substrate surface is done by coating the emulsion composition on the substrate surface using a coating method such as brushing, spraying, dipping, screen printing, ink jet printing and the like as described above. This is then dried. A more detail description is given by the following steps.

Firstly, the location on the substrate where the coating film will be formed is subjected to surface processing. The methods used for this surface processing vary in accordance with the substrate material, but usually includes plasma etching, UV (Ultraviolet) etching or solvent cleaning.

The location for coating film formation may be subjected to rough processing if necessary. Also, surface processing may be done after masking of those locations where the coating film will not be formed.

Next, the locations on the substrate for coating film formation are coated with the liquid emulsion composition using the above-described methods.

The liquid emulsion composition that has been coated on, is air dried at room temperature to thereby form the coating film.

The drying may be performed in a drying furnace, taking the heat resistance temperature of the substrate into consideration. For example, an electronic part with an internal permissible temperature of 125° C. may be dried at a temperature of about 125° C. with hot air from a drier or the like.

In the following description, the coating film formed from the emulsion composition of this invention will be referred to as a high radiation coating film. Also, the high radiation coating film having electric insulation properties is referred to as a non-conductive radiating coating film.

It is to be noted that the coating films formed from the emulsion compositions may all be used as non-conductive radiating coating films.

### WORKING EXAMPLE 6

In this working example, a cooling mechanism in which a high radiation coating film is formed on the surface of the substrate is used in an electronic part, and the cooling effect is checked using a conduction experiment. (The same experiment is used in Working Example 7)

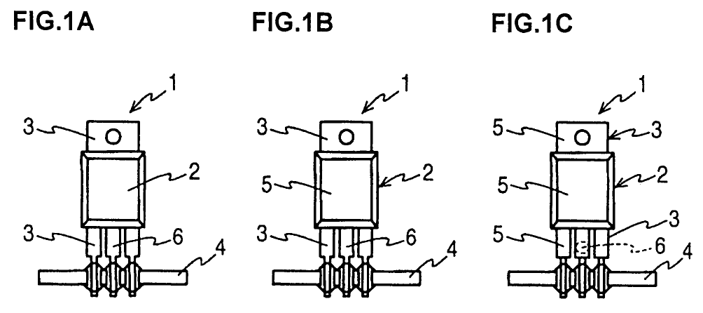

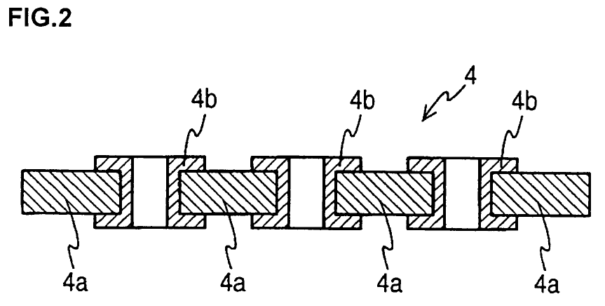

FIG. 1 is a is a front view of test specimens-of Working Example 6, and FIG. 2 is a cross-sectional view of the printed circuit board of Working Example 6.

FIG. 1 shows the electronic part 1 which is a terminal regulator (New Japan Radio Co., Ltd., Model No. 7805) in this working example.

The main body 2 of the electronic part 1 is a heat generating body which generates heat when electric power is applied.

A plurality of lead terminals 3 of the electronic part 1 are mounted to the main body 2, and they supply power to the main body 2 and transmit signals sent between the main body 2 and the printed circuit board 4. Also, the lead terminals 3 are heated due to the heat conductivity of the main body 2 which is a heat generating body.

The printed circuit board 4 is, as shown in FIG. 2, produced by forming a circuit pattern 4b onto a glass fiber reinforced epoxy resin or phenol resin plate-shaped base 4a, or a soft plate-shaped base 4a formed of a soft resin such as a polyimide resin. The lead terminals 3 of the electronic part 1 are bonded to this circuit pattern 4b using a bonding means such as soldering and the like, and the electronic part 1 is thereby mounted on the printed circuit board 4. In addition, heat flows from the lead terminals 3 that were heated by the main body 2 which is a heat generating body, to the circuit pattern 4b, and as a result the entire printed circuit board 4 becomes heated. The printed circuit board 4 of this working example has the base 4a of two layers of the glass fiber reinforced epoxy resin.

A non-conductive radiating film coating film is used in the high radiation coating film 5 in order to prevent electrical short circuiting.

A temperature measuring portion 6 is mounted at a position where a temperature equivalent to the internal temperature of the part can be measured, and it includes a thermometer such as a thermocouple and the like.

FIG. 1A shows the electronic part 1 on which the high radiation coating film 5 is not formed, and is also a blank test specimen used as a reference for checking the cooling effect of this experiment.

FIG. 1B is the test specimen, Specimen A, and the high radiation coating film 5 is formed with the substrate being all the surfaces of the main body 2 with the exception of the lead terminals 3.

FIG. 1C is the test specimen, Specimen B, and in addition to that of Specimen A, the substrate on which the high radiation coating film 5 is formed, is both surfaces including the lead terminals 3, with the exception of only the bonding portion thereof.

It is to be noted that the thickness of the high radiation coating film 5 in all the above cases is 100 μm.

The conduction experiment was carried out the printed circuit base 4 by mounting the three types of specimens described above inside a thermo-hygrostat at temperature 25° C., and applying electric power of 3W by passing a current. The internal temperature of the part was measured with the temperature measuring portion 6 after 40 minutes had elapsed, and when the temperature reached equilibrium. The results from this conduction experiment are shown in Table 1.

TABLE 1

| Electric | | | | | | |
|---|---|---|---|---|---|---|
| power | | | | | | |
| Applied | Test Specimen | | | Blank | Specimen A | Specimen B |
| | Region For | Main Body | Front surface | uncoated | coated | coated |
| | formation | Portion | Back surface | uncoated | coated | coated |

| | | | | |
|---|---|---|---|---|
| of coating | Lead terminal | uncoated | uncoated | coated |
| film | | | | |

| | | | | |
|---|---|---|---|---|
| 2 W | Temperature of part surroundings ° C. | 25 | 25 | 23 |
| | Internal temperature of part ° C. | 137.2 | 128.5 | 117.1 |
| | Part internal temperature reduction | standard | 8.7 | 20.1 |
| | per unit ° C. | | | |
| | Heat resistance ° C./W | 37.4 | 34.5 | 30.7 |
| | Permissible electric power when the | 1.337 | 1.449 | 1.629 |
| | temperature condition for use differs | | | |
| | by 50° C. W | | | |
| | Effect of mounting substrate on | standard | 8.4 | 21.8 |
| | permissible electric power % | | | |

It is to be noted that, permissible electric power when the temperature condition for use differs by 50° C. shown in Table 1 represents the permissible value for applied electric power when the permissible internal temperature of the part is for example 125° C. and the temperature surrounding the part is 75° C., and heat resistance shows an increase in internal temperature of the part when electric power of 1W is applied to the test specimen.

As shown in Table 1, when compared to that of the blank, the internal temperature of Specimen A which is a part that has the cooling mechanism in which the high radiation coating film 5 is formed on main body 2 is 8.7° C. lower, and there is an 8.4% increase in the permissible electric power when the temperature condition for use differs by 50° C.

Also, when compared to that of the blank, the internal temperature of specimen B which has a cooling mechanism in which the high radiation coating film 5 is formed on the main body 2 and on the lead terminals 3, is 20.1° C. lower, and there is a 21.8% increase in the permissible electric power when the temperature condition for use differs by 50° C.

As described above, in this working example, by installing a cooling mechanism having a high radiation coating film on the main body as a substrate, due to the excellent cooling effect thereof, the internal part temperature of the terminal regulator can be kept low, and the reliability and stability of the terminal regulator as an electronic part is improved.

Also, by providing the cooling mechanism on the lead terminal as a substrate, a more excellent cooling effect is seen, and the reliability and stability of the terminal regulator as an electronic part is improved even further.

### WORKING EXAMPLE 7

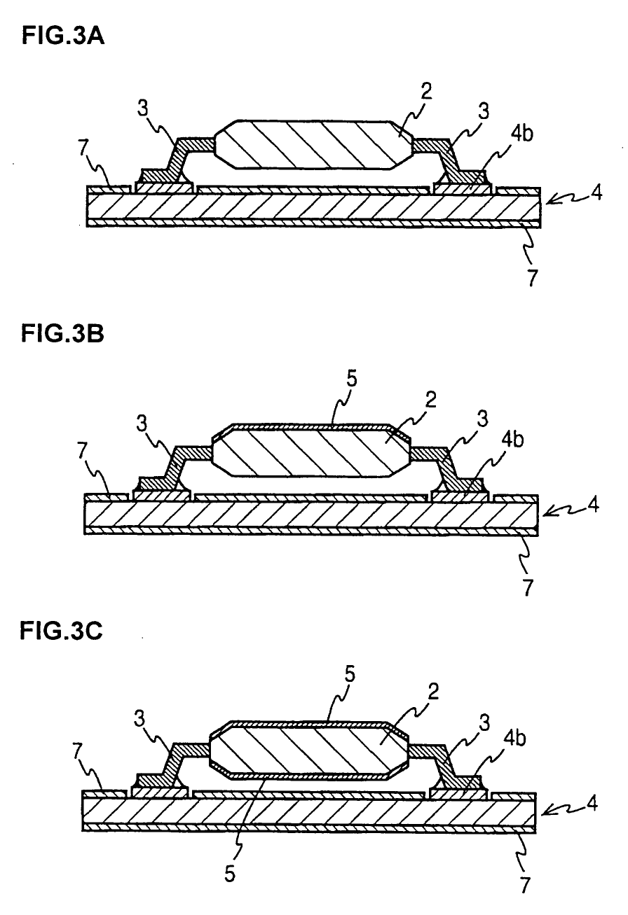

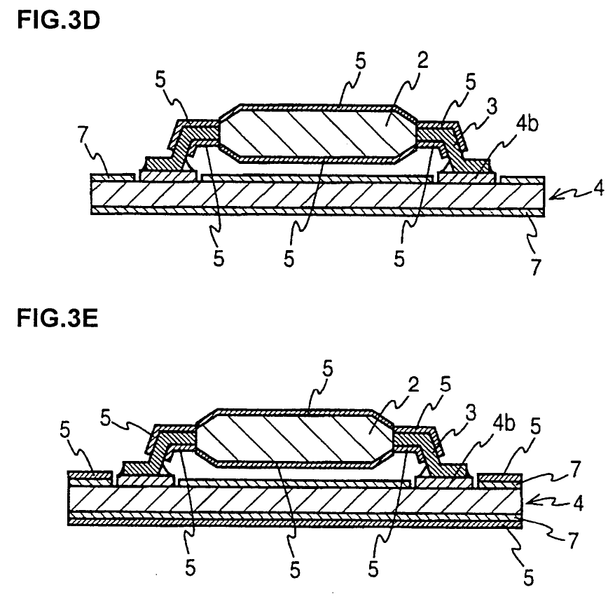

FIG. 3 is a cross-sectional view of the specimen of Working Example 7.

It is to be noted that the parts which are the same as the above described Working example 6 have been assigned the same numbers, and descriptions thereof have been omitted.

The resist layer 7 is an electrical insulation layer for ensuring insulation of and providing protection for the circuit pattern 4b, and is applied to the entire surface except for the bonding portions where soldering of the circuit patterns 4b for the front and back surfaces of the printed circuit board 4 is done.

The electronic part 1 of this working example which is shown in FIG. 3 is a QFP (Quad Flat Package) type 240 pin integrated circuit designed for this experiment.

It is to be noted that this integrated circuit has an element for temperature measurement incorporated therein, and in this working example the internal temperature of the part is measured using the temperature measuring element.

The printed circuit board 4 has the base 4a of 2 layers of glass resin reinforced epoxy resin for the base as is the case in Working Example 6.

The high radiation coating film 5 has a non-conductive radiating coating film in order to prevent electrical short circuiting.

FIG. 3A is a printed circuit board 4 mounted with an electronic part 1 that does not have the high radiation coating film 5 formed thereon, and is a blank test specimen that is used as reference in checking the cooling effect of the present experiment.

FIG. 3B is the test specimen, Specimen C, and the substrate on which the high radiation coating film 5 is formed, is only the front surface of the main body 2.

FIG. 3C is the test specimen, Specimen D which in addition to that of Specimen C in which the high radiation coating film 5 is formed on the front surface of the main body 2, it is also formed on the opposite side which is the back surface of the main body 2 , and the printed circuit board 4 side.

FIG. 3D is the test specimen, Specimen E, and in addition to that of Specimen D, the substrate on which the high radiation coating film 5 is formed is all the surfaces of the lead terminals 3, with the exception of the bonding portions thereof.

FIG. 3E is the test specimen, Specimen F, and in addition to the substrate of Specimen E, the high radiation coating film 5 is formed the front surface of the printed circuit board 4 with the exception of the bonding portions of the lead terminals 3, and on the entire back surface thereof.

It is to be noted that the thickness of the high radiation coating film 5 in all of the above cases is 100 μm.

The conduction experiment was carried out by mounting the 5 types of specimens described above at temperature 25° C. inside a thermo-hygrostat, and applying electric power by passing currents of 2W and 3W. The internal temperature of the part was measured with the temperature measuring portion 6 after 40 minutes had elapsed, and when the temperature reached equilibrium.

The results from this conduction experiment are shown in Table 2.

TABLE 2

| Electric | | | | | | | | |
|---|---|---|---|---|---|---|---|---|
| Power | | | | | | | | |
| Applied | Test Specimen | | | Blank | Specimen C | Specimen D | Specimen E | Specimen F |
| | Region | Main | Front | uncoated | coated | coated | coated | coated |
| | for | body | surface | | | | | |
| | formation | | Back | uncoated | uncoated | coated | coated | coated |
| | of | | surface | | | | | |
| | coating | Lead terminals | | uncoated | uncoated | uncoated | coated | coated |
| | film | Substrate | Front | uncoated | uncoated | uncoated | uncoated | coated |
| | | | surface | | | | | |
| | | | Back | uncoated | uncoated | uncoated | uncoated | coated |
| | | | surface | | | | | |

| | | | | | | |
|---|---|---|---|---|---|---|
| 2 W | Temperature of part | 25 | 25 | 25 | 25 | 25 |
| | surrounding ° C. | | | | | |
| | Internal temperature of | 81.6 | 81.5 | 78.4 | 78.2 | 76.2 |
| | part ° C. | | | | | |
| | Part internal temperature | reference | 0.1 | 3.2 | 3.4 | 5.4 |
| | reduction per unit ° C. | | | | | |
| | Heat resistance ° C./W | 28.3 | 28.25 | 26.7 | 26.6 | 25.6 |
| | Permissible electric power | 1.767 | 1.770 | 1.873 | 1.880 | 1.953 |
| | when the temperature | | | | | |
| | condition for use differs by | | | | | |
| | 50° C. W | | | | | |
| | Effect of mounting | reference | 0.2 | 6.0 | 6.4 | 10.5 |
| | substrate on permissible | | | | | |
| | electric power mounted | | | | | |
| | substrate % | | | | | |
| 3 W | Temperature of part | 25 | 25 | 25 | 25 | 25 |
| | surrounding ° C. | | | | | |
| | Internal temperature of | 107.3 | 105.8 | 103.2 | 103.0 | 101.7 |
| | part ° C. | | | | | |
| | Part internal temperature | reference | 1.5 | 4.1 | 4.3 | 5.6 |
| | reduction per unit ° C. | | | | | |
| | Heat resistance ° C./W | 27.6 | 26.9 | 26.1 | 26 | 25.6 |
| | Permissible electric power | 1.812 | 1.856 | 1.918 | 1.923 | 1.956 |
| | when the temperature | | | | | |
| | condition for use differs by | | | | | |
| | 50° C. W | | | | | |
| | Effect of mounting | reference | 2.4 | 5.8 | 6.1 | 7.9 |
| | substrate on permissible | | | | | |
| | electric power mounted | | | | | |
| | substrate % | | | | | |

It is to be noted that the permissible electric power when the temperature condition for use differs by 50° C. and heat resistance shown in Table 2 are the same as in Working Example 6 above.

As shown in Table 2, from the Specimen C that is installed with the main body 2 having the cooling mechanism in which the high radiation coating film 5 is formed, to Specimen F in which the cooling mechanism is provided on almost the entire surface of the printed circuit board 4 on which the electronic part 1 is installed, the internal temperature of the part was reduced sequentially when compared to that of the blank in the order Specimen C, D, E to F, as locations on which the cooling mechanism was provided expanded in that order. The permissible electric power when the temperature condition for use differs by 50° C. also increased in that order.

As described above, in this working example the same cooling effect can be obtained as in Working Example 6, and the reliability and stability of the integrated circuit as an electronic part can be improved.

In addition, by installing the cooling mechanism in the printed circuit board the heat that flows to the printed circuit board can be effectively radiated, and thus the cooling effect of the electronic part in which this cooling mechanism is installed can be further increased.

The cooling effect in the electronic part 1 due to the cooling mechanism of the present invention, which was demonstrated in Working Examples 6 and 7 can also be obtained in the following embodiments.

Embodiment 1

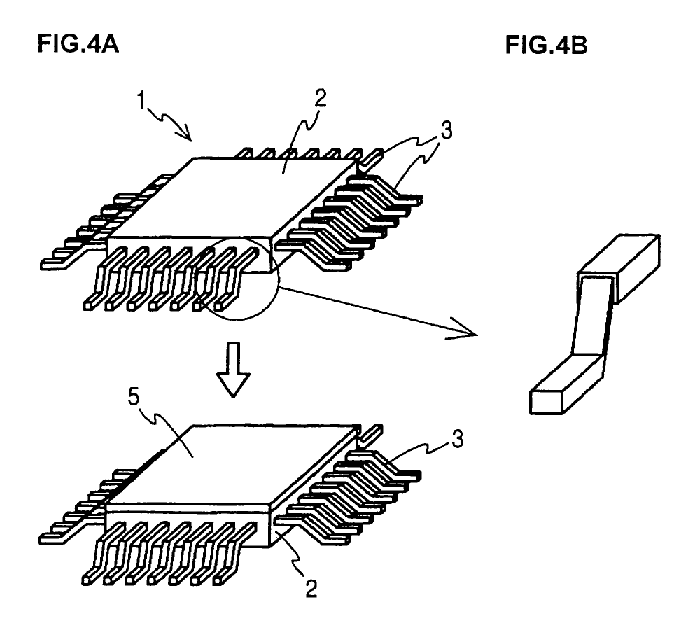

FIG. 4 is a perspective view of Embodiment 1.

It is to be noted that the parts which are the same as the above described Working example 6 have been assigned the same numbers, and descriptions thereof have been omitted. This embodiment which shows the cooling mechanism being used in a unit of a QFP type integrated circuit as the electronic part 1.

As shown in FIG. 4A, when forming the high radiation coating film 5 on the front surface of the main body 2 as the substrate, the high radiation coating film 5 formed on the entire front surface. In addition when the high radiation coating film 5 is formed not only on the front surface, but on the back and side surfaces as well, the cooling effect is further increased.

When the high radiation coating film 5 is formed on the lead terminals 3 as the substrate, because this embodiment is for application to one unit, as shown in FIG. 4B, the high radiation coating film 5 is formed using the high radiation non-conductive film, and avoiding the bonding portion where soldering and the like is carried out.

Embodiment 2

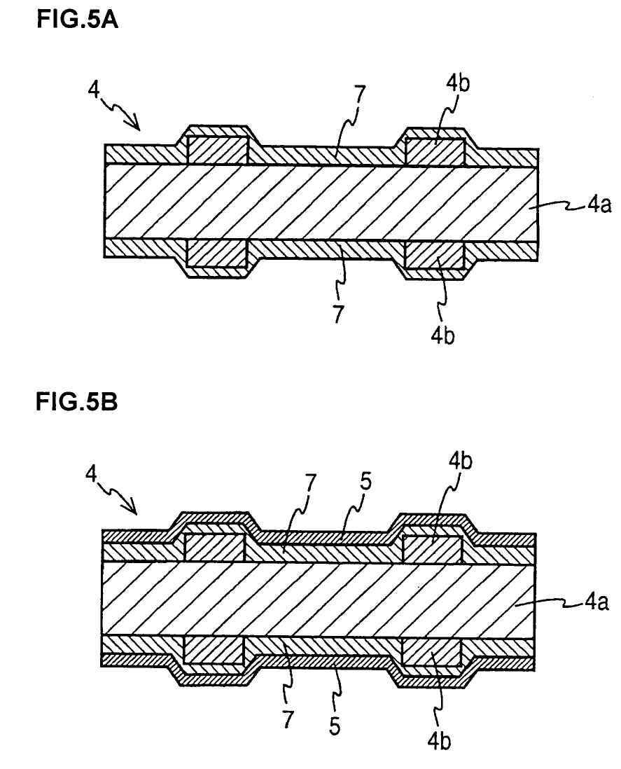

FIG. 5 is a cross-sectional view of Embodiment 2.

It is to be noted that the parts which are the same as the above-described Working example 6 and 7 have been assigned the same numbers, and descriptions thereof have been omitted.

This embodiment shows the example in which the cooling mechanism is applied to a unit of the printed circuit board 4 as the substrate.

As shown in FIG. 5A, when the high radiation coating film 5 is formed on the front and back surfaces of the printed circuit board 4, it is formed, on the entire front and back surfaces except for the bonding portion where soldering and the like is carried out, using the high radiation non-conductive film.

It is to be noted that the high radiation coating film 5 may be formed on the entire surface including the side surfaces, or it may be formed only on the front surface or only on the back surface.

When the high radiation coating film 5 is formed on the printed circuit board 4 to which the resist layer 7 has been applied, as shown in FIG. 5B, the high radiation coating film 5 is formed as described above on top of the resist layer 7.

Embodiment 3

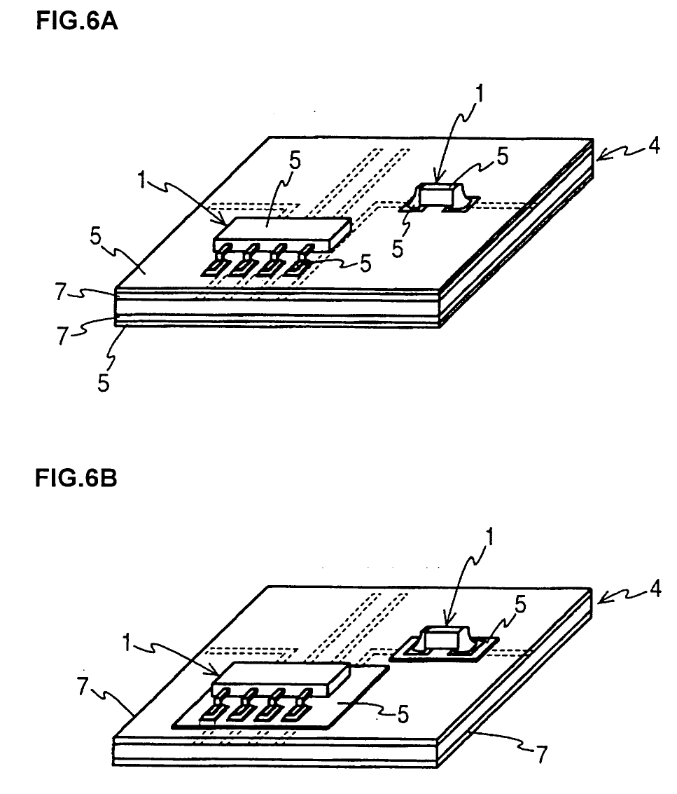

FIG. 6 is a perspective view of Embodiment 3.

It is to be noted that the parts which are the same as the above described Working examples 6 and 7 have been assigned the same numbers, and descriptions thereof have been omitted.

This embodiment shows an example in which the cooling mechanism is applied to the printed circuit board 4 having electronic parts 1 installed thereon as the substrate.

In this embodiment, the electronic parts 1 which are a SOP (Small Outline Package) type integrated circuit and chip are installed on a printed circuit board 4 that has the resist layer 7.

When the high radiation coating film 5 is formed on the printed circuit board 4 on which these types of electronic parts 1 are installed, the non-conductive radiating film coating is used to form the high radiation coating film 5 on the entire front and back surfaces as shown in FIG. 6A.

In this case, the high radiation coating film 5 is not formed on the bonding portions where soldering and the like is done or the insertion portions for the connectors and the like (not shown).

It is to be noted that the high radiation coating film 5 may be formed on all surface including the side surfaces, or it may be formed only on the front surface or only on the back surface.

Also, as shown in FIG. 6B, the high radiation coating film 5 may be formed only in the vicinity of the electronic parts 1 which are heat generating bodies.

In this manner, by forming the high radiation coating film 5 of this invention the printed circuit board 4 having electronic parts 1 having installed thereon, the need to form the high radiation coating film 5 on the part units in advance is eliminated, and formation of the high radiation coating film 5 for the cooling mechanism becomes simplified.

In addition, because the high radiation coating film 5 is a non-conductive radiating coating film, the high radiation coating film 5 may be formed on the bonding portions where soldering and the like is carried out, and the formation of the high radiation coating film 5 is also simplified.

It is to be noted that in the above description the resist layer 7 was applied to the printed circuit board 4 beforehand, but after the electronic parts 1 are installed on the printed circuit board 4, the resist layer 7 may be applied to the entire printed circuit board 4 with the electronic parts 1 installed thereon with the exception of the connector portion, as in the case of the non-conductive radiating coating film. As a result, a high radiation coating film 5 that is conductive may be formed on the bonding portions where soldering and the like are carried out also.

Also, when the high radiation coating film 5 is being formed, if the non-conductive radiating coating film is used, there is no need to take the trouble to avoid forming it on the bonding portions where circuit patterning or soldering is carried out, and thus the cooling mechanism of the present invention can be easily installed.

In this manner, this invention achieves the effect of obtaining a coating film with excellent cooling and heat shielding effects as a result of the emulsion composition being one in which a metallic oxide is included in a silicone resin emulsion.

That is to say, for parts and devices that generate heat a cooling effect is exhibited, while for those parts and devices that generate little heat, but which operate in a high temperature environment, a heat shielding effect is exhibited. In both cases the temperature of the parts and devices themselves are effectively decreased, and thus the reliability and stability of these parts and devices are improved.

In addition, the temperature of the parts themselves can be easily decreased by coating the emulsion composition or by pasting on a heat radiating/heat shielding sheet without the need for a heat-radiating fin or a cooling fan. This may contribute to making it possible for devices and apparatuses installed with these parts and devices to be made smaller.

Also, by adding a nitride with excellent conductive properties as well, the cooling and heat shielding properties of the coating film formed from the emulsion composition are further improved.

Further, by forming the coating film of the emulsion composition onto at least a portion of the surface of the substrate, due to the cooling and heat shielding effects thereof, temperature increase of the electronic parts can be reduced, and thus the reliability and stability of the parts can be increased.

What is claimed is:

1. An emulsion composition in which a metallic oxide is included in an emulsion containing a silicone resin.

2. An emulsion composition of claim 1, wherein the metallic oxide comprises kaolin.

3. An emulsion composition of claim 1, wherein the metallic oxide comprises silicon oxide.

4. An emulsion composition of claim 1, wherein the metallic oxide comprises aluminum oxide.

5. An emulsion composition of claim 1, wherein the metallic oxide comprises at least one of titanium oxide, zirconium oxide; antimony oxide, germanium oxide; boron oxide; calcium oxide; barium oxide; strontium oxide; bismuth oxide; copper oxide; and talc.

6. An emulsion composition of claim 1, including at least one nitride from the group including silicon nitride, aluminum nitride, zirconium nitride, copper nitride, strontium nitride, titanium nitride, and barium nitride.

7. An emulsion composition of claim 1, wherein the proportion of the emulsion containing the silicone resin in the emulsion composition is 30-70 weight percent.

8. An emulsion composition of claim 2, wherein the proportion of kaolin in the emulsion composition is 7-20 weight percent.

9. A coating film which is formed from an emulsion composition in which a metallic oxide is included in an emulsion containing a silicone resin.

10. A coating film of claim 9, wherein the metallic oxide comprises kaolin.

11. A cooling mechanism in which a coating film formed from an emulsion composition in which a metallic oxide is included in an emulsion containing a silicone resin, is formed on at least one portion of surface of a substrate.

12. A cooling mechanism of claim 11, wherein the metallic oxide comprises kaolin.

13. A cooling mechanism of claim 11, wherein the coating film is a non-conductive radiating coating film.

14. A cooling mechanism of claim 11, wherein the substrate is the main body of an electronic part.

15. A cooling mechanism of claim 11, wherein the substrate is a lead terminal of an electronic part.

16. A cooling mechanism of claim 11, wherein the substrate is a printed circuit board.

17. A cooling mechanism of claim 11, wherein the substrate is a printed circuit board on which an electronic part has been installed.

18. A cooling mechanism of claim 17, wherein the coating film is formed on the printed circuit board on which an electronic part has been installed via a resist layer.
